(19) United States
(12) Patent Application Publication
(10) Pub. No.: US 2008/0312289 A1
(43) Pub. Date: Dec. 18, 2008

(54) Use of Cni-Sl Formulations for Controlling White Fly

(75) Inventors: Isidro Bailo-Schleiermacher, Leverkusen (DE); Kai-Uwe Bruggen, Mumbai (IN); Heike Hungenberg, Langenfeld (DE); Wolfgang Thielert, Odenthal (DE); Lorna Elizabeth Davies, Kansas City, MO (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience AG, Monheim (DE)

(21) Appl. No.: 12/066,031

(22) PCT Filed: Aug. 26, 2006
(86) PCT No.: PCT/EP2006/008388

§ 371 Date: Jul. 23, 2008

(30) Foreign Application Priority Data
Sep. 9, 2005 (DE) 10 2005 042 881.9

(51) Int. Cl. A01N 43/40; A01P 7/04

(52) U.S. Cl. 514/341

(57) ABSTRACT

Method of controlling eggs and nymphal stages of whitefly by the spray application of agrochemical formulations containing at least one insecticide from the series of the neonicotinyls, at least one fatty alcohol ethoxylate of the formula (I), at least one solvent from the group consisting of dimethyl sulphoxide, N-methylpyrrolidone and butyrolactone, and, if appropriate, additives.

Within the large group of sucking pests such as, for example, representatives from the orders Heteroptera and Homoptera, whiteflies (genus: Aleyrodina; family: Aleyrodidae), among them species such as Trialeurodes vaporariorum and in particular Bemisia tabaci are worldwide pest species in the production of many types of cereals and vegetables (Byrne & Bellows, Annual Review of Entomology (1991) 36, 431-457; Byrne et al., in: Whiteflies: their bionomics, pest status and management, Intercept, Andover, UK, 1990, pp. 227-267). Controlling this pest is therefore of great economical importance. The pesticides employed for this purpose include, inter alia, those which contain insecticides from the neonicotinyl series (for example imidacloprid or acetamiprid). Such a composition is sold for example under the name Confidor® SL 200 from Bayer CropScience (Monheim, Germany).

While these compositions are very effective against all lifecycles of the pest when they are applied systemically (as a pourable solution), they only afford inefficient protection against eggs and nymphs when applied as a spray treatment (Horowitz et al., Bulletin of Entomological Research (1988) 88, 437-442). The main reason is that eggs and nymphs are located on the underside of the leaves, where they are largely immobile. In the case of a traditional spray treatment, the insecticides therefore do not reach them, in contrast to the adults, and, after they have continued their development they lead to reinfestation of the plant with pests.

It has now been found, surprisingly, that certain formulations of neonicotinyls, when applied as a spray treatment, show a markedly improved effect against eggs and nymphal stages of whitefly over the established formulations when used in the same manner.

The invention therefore relates to the use of active substance formulations containing at least one insecticide from the neonicotinyl series for controlling eggs and nymphal stages of whitefly by means of spray application.

Formulations which are suitable for the use according to the invention contain
between 0.1 and 30% by weight of fatty alcohol ethoxylate of the formula (I),

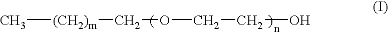

in which
   m represents average values of between 8.0 and 13.0 and
   n represents average values of between 6.0 and 17.0,
between 1 and 50% by weight of active substance from the neonicotinyl group,
between 1 and 80% by weight of dimethyl sulphoxide, N-methylpyrrolidone and/or butyrolactone, and
between 0 and 20% by weight of additives.

The plant treatment compositions according to the invention are prepared in such a way that the components are mixed with one another in the desired ratios. In general, a procedure is followed in which an active substance from the neonicotinyl group is initially introduced, and the remaining constituents are then added with stirring in any desired order.

When preparing the plant treatment compositions according to the invention, the temperatures can be varied within a certain range. In general, the process will be carried out at temperatures of between 10° C. and 50° C., preferably at room temperature.

Apparatuses which are suitable for the preparation of the plant treatment compositions according to the invention are customary apparatuses which are employed for the preparation of agrochemical formulations.

Suitable additives which may be present in the plant treatment compositions according to the invention are further agrochemical active substances and crystallization inhibitors, wetters, emulsifiers and also water.

Insecticides from the neonicotinoid series can be described by the following formula (II)

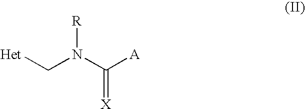

in which
Het represents a heterocycle selected from the following group of heterocycles: 2-chloropyrid-5-yl, 2-methylpyrid-5-yl, 1-oxido-3-pyridino, 2-chloro-1-oxido-5-pyridino, 2,3-dichloro-1-oxido-5-pyridino tetrahydrofuran-3-yl, 5-methyl-tetrahydrofuran-3-yl, 2-chlorothiazol-5-yl,
A represents N(R¹)(R²) or S(R²),
   where
R¹ represents hydrogen, C₁-C₆-alkyl, phenyl-C₁-C₄-alkyl, C₃-C₆-cycloalkyl, C₂-C₆-alkenyl or C₂-C₆-alkynyl, and
R² represents C₁-C₆-alkyl, C₂-C₆-alkenyl, C₂-C₆-alkynyl, —C(═O)—CH₃ or benzyl,
R represents C₁-C₆-alkyl, C₂-C₆-alkenyl, C₂-C₆-alkynyl, —C(═O)—CH₃ or benzyl or together with R² represents one of the following groups:
—CH₂—CH₂—, —CH₂—CH₂—CH₂—, —CH₂—O—CH₂—, —CH₂—S—CH₂—, —CH₂—NH—CH₂—, —CH₂—N—(CH₃)—CH₂— and
X represents N—NO₂, N—CN or CH—NO₂
   (see, for example, EP-A1-192 606, EP-A2-580 533, EP-A2-376 279, EP-A2-235 725).

The following compounds which can be used in accordance with the invention may be mentioned individually.

A compound which is preferably used in accordance with the invention is thiamethoxam.

Thiamethoxam has the formula

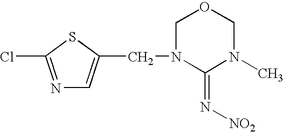

and is known from EP A2 0 580 533.

A further compound which is preferably used in accordance with the invention is clothianidin.

Clothianidin has the formula

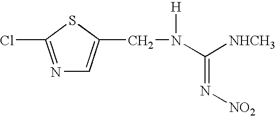

and is known from EP A2 0 376 279.

A further compound which is preferably used in accordance with the invention is thiacloprid.

Thiacloprid has the formula

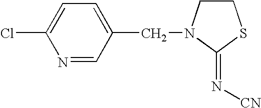

and is known from EP A2 0 235 725.

A further compound which is preferably used in accordance with the invention is dinotefuran.

Dinotefuran has the formula

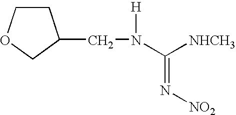

and is known from EP A1 0 649 845.

A further compound which is preferably used in accordance with the invention is acetamiprid.

Acetamiprid has the formula

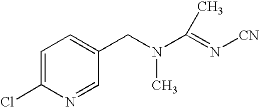

and is known from WO A1 91/04965.

A further compound which is preferably used in accordance with the invention is nitenpyram.

Nitenpyram has the formula

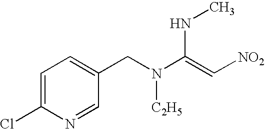

and is known from EP A2 0 302 389.

A further compound which is preferably used in accordance with the invention is imidacloprid.

Imidacloprid has the formula

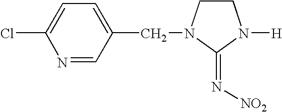

and is known from EP 0 192 060.

A compound which is especially preferably used in accordance with the invention is imidacloprid.

Formula (I) hereinabove provides a general definition of the alkanol alkoxylates. These substances take the form of mixtures of substances of the type indicated with different chain lengths. This is why average values, which may deviate from integers, are calculated for the indices.

Fatty alcohol ethoxylates of the formula (I) which can preferably be used are those in which
m represents average values of between 9.0 and 12.0 and
n represents average values of between 7.0 and 9.0.

Very especially preferred is fatty alcohol ethoxylate of the formula (I) in which
m represents the average value of 10.5 and
n represents the average value of 8.4.

The alkanol alkoxylates of the formula indicated are known or can be prepared by known methods (cf. WO 98-35 553, WO 00-35 278 and EP-A 0 681 865).

The formulations which can be employed in accordance with the invention can, in a particular embodiment, additionally contain at least one further active substance (insecticides, attractants, sterilants, bactericides, acaricides, nematicides, fungicides, growth-regulating substances or herbicides). The insecticides include, for example, phosphoric esters, carbamates, carboxylic esters, chlorinated hydrocarbons, phenylurea, substances produced by microorganisms and the like.

Especially advantageous mixing partners are, for example, the following:

### Fungicides:

### Nucleic Acid Synthesis Inhibitors

benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid

### Mitosis and Cell Division Inhibitors

benomyl, carbendazim, diethofencarb, fuberidazole, pencycuron, thiabendazol, thiophanate-methyl, zoxamid

### Respiratory Chain Complex I Inhibitors

diflumetorim

### Respiratory Chain Complex II Inhibitors

boscalid, carboxin, fenfuram, flutolanil, furametpyr, mepronil, oxycarboxin, penthiopyrad, thifluzamid

### Respiratory Chain Complex III Inhibitors

azoxystrobin, cyazofamid, dimoxystrobin, enestrobin, famoxadon, fenamidon, fluoxastrobin, kresoximmethyl, metominostrobin, orysastrobin, pyraclostrobin, picoxystrobin

### Uncouplers

dinocap, fluazinam

### ATP Production Inhibitors

fentin acetate, fentin chloride, fentin hydroxide, silthiofam

### Amino Acid and Protein Biosynthesis Inhibitors

andoprim, blasticidin-S, cyprodinil, kasugamycin, kasugamycin hydrochloride hydrate, mepanipyrim, pyrimethanil

### Signal Transduction Inhibitors

fenpiclonil, fludioxonil, quinoxyfen

### Fat and Membrane Synthesis Inhibitors

chlozolinate, iprodion, procymidon, vinclozolin
ampropylfos, potassium-ampropylfos, edifenphos, iprobenfos (IBP), isoprothiolan, pyrazophos
tolclofos-methyl, biphenyl
iodocarb, propamocarb, propamocarb hydrochloride

### Ergosterol Biosynthesis Inhibitors

fenhexamid,
azaconazole, bitertanol, bromuconazole, cyproconazole, diclobutrazol, difenoconazole, diniconazole, diniconazole-M, epoxiconazole, etaconazole, fenbuconazole, fluquinconazole, flusilazol, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidol, nuarimol, pyrifenox, triforin, pefurazoat, prochloraz, triflumizol, viniconazole,
aldimorph, dodemorph, dodemorphacetat, fenpropimorph, tridemorph, fenpropidin, spiroxamin,
naftifin, pyributicarb, terbinafin

### Cell Wall Synthesis Inhibitors

benthiavalicarb, bialaphos, dimethomorph, flumorph, iprovalicarb, polyoxins, polyoxorim, validamycin A

### Melanin Biosynthesis Inhibitors

capropamid, diclocymet, fenoxanil, phtalid, pyroquilon, tricyclazol

### Resistance Induction

acibenzolar-5-methyl, probenazol, tiadinil

### Multisite

captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, fluorofolpet, guazatine, guazatine acetate, iminoctadine, iminoctadine albesilate, iminoctadine triacetate, mancopper, mancozeb, maneb, metiram, metiram-zinc, propineb, sulphur and sulphur preparations comprising calcium polysulphide, thiram, tolylfluanid, zineb, ziram

### Unknown Mechanism

amibromdol, benthiazole, bethoxazin, capsimycin, carvone, quinomethionate, chloropicrin, cufraneb, cyflufenamid, cymoxanil, dazomet, debacarb, diclomezine, dichlorophen, dicloran, difenzoquat, difenzoquat methyl sulphate, diphenylamine, ethaboxam, ferimzone, flumetover, flusulfamid, fluopicolid, fluoroimide, hexachlorobenzene, 8-hydroxyquinoline sulphate, irumamycin, methasulphocarb, metrafenon, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperaline, propanosine-sodium, proquinazid, pyrrolenitrine, quintozene, tecloftalam, tecnazene, triazoxide, trichlamid, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-alpha-(methoxymethylene)benzacetate, 4-chloro-alpha-propynyloxy-N-[2-[3-methoxy-4-(2-propynyloxy)phenyl]ethyl]benzacetamide, (2S)-N-[2-[4-[[3-(4-chlorophenyl)-2-propynyl]oxy]-3-methoxyphenyl]ethyl]-3-methyl-2-[(methylsulphonyl)amino]butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl) [1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethylidene]amino]oxy]methyl]-alpha-(methoxyimino)-N-methyl-alphaE-benzacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazol-1-carbothioic acid, 2-(2-{[6-(3-chloro-2-methylphenoxy)-5-fluoropyrimidin-4-yl]oxy}phenyl)-2-(methoxyimino)-N-methylacetamide

### Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides:

### Acetylcholine Esterase (AChE) Inhibitors

carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chloropyrifos (-methyl/-ethyl), coumaphos, cyanofenphos, cyanophos, chlorfenvinphos, demeton-5-methyl, demeton-5-methylsulphon, dialifos, diazinon, dichlofenthion, dichlorvos/DDVP, dicrotophos, dimethoate, dimethylvinphos, dioxabenzofos, disulphoton, EPN, ethion, ethoprophos, etrimfos, famphur, fenamiphos, fenitrothion, fensulphothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

### Sodium Channel Modulators/Voltage-Dependent Sodium Channel Blockers

pyrethroids,
for example acrinathrin, allethrin (d-cis-trans, d-trans), beta-cyfluthrin, bifenthrin, bioallethrin, bioallethrin-5-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
DDT
oxadiazines,
for example indoxacarb

### Acetylcholine Receptor Agonists/Antagonists

Chloronicotinyls,
for example acetamiprid, clothianidin, dinotefuran, imidacloprid, nitenpyram, nithiazine, thiacloprid, thiamethoxam
nicotine, bensultap, cartap

### Acetylcholine Receptor Modulators

spinosyns,
for example spinosad

### GABA-Controlled Chloride Channel Antagonists

organochlorines,
for example camphechlor, chlordane, endosulphan, gamma-HCH, HCH, heptachlor, lindane, methoxychlor
fiprols,
for example acetoprole, ethiprole, fipronil, pyrafluprole, pyriprole, vaniliprole

### Chloride Channel Activators

mectins,
for example avermectin, emamectin, emamectin-benzoate, ivermectin, milbemycin

### Juvenile Hormone Mimetics,

for example diofenolan, epofenonane, fenoxycarb, hydroprene, kinoprene, methoprene, pyriproxifen, triprene

### Ecdysone Agonists/Disruptors

diacylhydrazines,
for example chromafenozide, halofenozide, methoxyfenozide, tebufenozide

### Chitin Biosynthesis Inhibitors

benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
buprofezin
cyromazine

### Inhibitors of Oxidative Phosphorylation, ATP Disruptors

diafenthiuron
organotin compounds
for example azocyclotin, cyhexatin, fenbutatin-oxide

### Uncouplers of Oxidative Phoshorylation by Interrupting the H Proton Gradient

pyrroles,
for example chlorfenapyr
dinitrophenols,
for example binapacyrl, dinobuton, dinocap, DNOC

### Site-I Electron Transport Inhibitors

METIs,
for example fenazaquin, fenpyroximate, pyrimidifen, pyridaben, tebufenpyrad, tolfenpyrad
hydramethylnon
dicofol

### Site-II Electron Transport Inhibitors

rotenone

### Site-III Electron Transport Inhibitors

acequinocyl, fluacrypyrim

### Microbial Disruptors of the Insect Gut Membrane

Bacillus thuringiensis strains

### Fat Biosynthesis Inhibitors

tetronic acids,
for example spirodiclofen, spiromesifen
tetramic acids,
for example spirotetramat (CAS-Reg.-No.: 203313-25-1) and 3-(2,5-dimethylphenyl)-8-methoxy-2-oxo-1-azaspiro[4.5]dec-3-en-4-yl ethyl carbonate (also known as: carbonic acid, 3-(2,5-dimethylphenyl)-8-methoxy-2-oxo-1-azaspiro[4.5]dec-3-en-4-yl ethyl ester, CAS-Reg.-No.: 382608-10-8)
carboxamides,
for example flonicamid
octopaminergic agonists,
for example amitraz

### Inhibitors of Magnesium-Stimulated ATPase,

propargite
benzoic acid dicarboxamides,
for example flubendiamide
nereistoxin analogues,
for example thiocyclam hydrogen oxalate, thiosultap-sodium

### Biologicals, Hormones or Pheromones

azadirachtin, Bacillus spec., Beauveria spec., codlemone, Metarrhizium spec., Paecilomyces spec., Thuringiensin, Verticillium spec.
   Active Compounds with Unknown or Unspecific Mechanisms of Action
fumigants,
for example aluminium phosphide, methyl bromide, sulphuryl fluoride
antifeedants,
for example cryolite, flonicamid, pymetrozine
mite growth inhibitors,
for example clofentezine, etoxazole, hexythiazox
amidoflumet, benclothiaz, benzoximate, bifenazate, bromopropylate, buprofezin, quinomethionate, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

The content of the individual components in the plant treatment compositions according to the invention can be varied within a certain range. Preferred plant treatment compositions are those in which the concentrations
of fatty alcohol ethoxylate of the formula (I) are between 0.5 and 15% by weight,
of active substance from the neonicotinyl group between 2.5 and 30% by weight,
of dimethyl sulphoxide, N-methylpyrrolidone and/or butyrolactone between 30 and 80% by weight and
of additives between 0 and 15% by weight.

If the plant treatment compositions according to the invention take the form of ready-to-use products, then those are preferred in which the content
of fatty alcohol ethoxylate of the formula (I) is between 0.01 and 0.2% by weight,
of active substance from the neonicotinyl group between 0.01 and 0.03% by weight,
of dimethyl sulphoxide, N-methylpyrrolidone and/or butyrolactone between 0 and 50% by weight and
of additives between 0 and 95% by weight.

The plant treatment compositions according to the invention are prepared in such a manner that the components are mixed with one another in the desired ratios. In general, a procedure is followed in which an active substance from the neonicotinyl group is initially introduced and the remaining constituents are then added with stirring in any desired order.

When preparing the plant treatment compositions according to the invention, the temperatures can be varied within a certain range. In general, the process is carried out at temperatures between 10° C. and 50° C., preferably at room temperature.

Suitable apparatuses which are employed for the preparation of agrochemical formulations are suitable as apparatuses for the preparation of the plant treatment compositions according to the invention.

Formulations which can be used in accordance with the invention can be converted into homogeneous spray mixtures by dilution with water. These spray mixtures are applied by spraying.

The application rate of the formulations used in accordance with the invention can be varied within a substantial range. It depends on the agrochemical active substances in question and on their content in the formulations.

The plant treatment compositions according to the invention can be applied either as such or after previous dilution with water or other diluents, that is to say for example in the form of emulsions, suspensions, solutions or aerosols. They are applied by spraying, pouring, atomizing, injecting or brushing on.

The formulations according to the invention can be used to treat all plants and plant parts. In the present context, plants are understood as meaning all plants and plant populations, such as desired and undesired wild plants or crop plants (including naturally occurring crop plants). Crop plants can take the form of plants which can be obtained by conventional breeding and optimization methods or by biotechnological and recombinant methods or by combinations of these methods, including the transgenic plants and including the plant varieties capable or not of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruiting bodies, fruits and seeds, and also roots, tubers and rhizomes. The plant parts also include harvested material and vegetative and generative propagation material, for example cuttings, tubers, rhizomes, slips and seeds.

What must be emphasized here is the especially advantageous effect of the compositions according to the invention regarding the use in cereal plants such as, for example, wheat, oats, barley, spelt, triticale and rye, but also in maize, millet and sorghum, rice, sugarcane, soybeans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, cumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leafy vegetables such as, for example, endives, corn salad, Florence fennel, lettuce, cos lettuce, Swiss chard, spinach and chicory, cabbages such as, for example, cauliflower, broccoli, Chinese leaves, borecole (curly kale, feathered cabbage), kohlrabi, Brussels sprouts, red cabbage, white cabbage and savoy cabbage, fruit vegetables such as, for example, aubergines, cucumbers, capsicums, table pumpkins, tomatoes, courgettes and sweet corn, root vegetables such as, for example, celeriac, early turnips, carrots, including yellow cultivars, radish, including small radish, beetroot, scorzonera and celery, pulses such as, for example, beans and peas, and bulb vegetables such as, for example, leeks and table onions).

The treatment according to the invention of the plants and plant parts with the formulations according to the invention is carried out by spraying, vaporizing or misting, preferably by spraying.

The agrochemical active substances which are present display a better biological activity against all stages of whitefly than when applied in the form of the corresponding traditional formulations.

The invention is illustrated by the examples which follow. The examples are not to be construed as limiting.

### PREPARATION EXAMPLE

To prepare formulation,
20 g of imidacloprid
   are treated with stirring at room temperature in succession with
5 g of the polyvinylpyrrolidone/polyvinyl alcohol copolymer known as Luviskol VA 64 (BASF),
10 g of the fatty alcohol ethoxylate of the formula (I) which is known as Genapol C-100 (Clariant), in which
   m represents the average value of 10.5 and
   n represents the average value of 8.4,
and
65 g of N-methylpyrrolidone.

After the addition has ended, stirring is continued for 5 minutes at room temperature. This gives a homogeneous fluid.

### USE EXAMPLE

Cotton plants (Gossypium hirsutum) which are infested with whitefly (Bemisia tabaci) eggs and larvae are sprayed with a composition of the desired composition and concentration.

After the desired time, the destruction is determined in %. In this context, 100% means that all of the animals were destroyed; 0% means that no animals were destroyed.

| | % destruction after stated time at stated active | | | |
|---|---|---|---|---|
| | compound concentration | | | |
| Composition | Eggs/14 d | L1/10 d | L3/13 d | Adults/6 d |
| Prior art | 60 | 0 | 0 | 60 |
| Confidor ® SL200 | 150 g/ha | 12.5 g/ha | 5 g/ha | 5 g/ha |
| Inventive | 100 | 90 | 50 | 100 |
| Confidor ® SL200 forte | 150 g/ha | 12.5 g/ha | 5 g/ha | 5 g/ha |

1. A method for controlling eggs and nymphal stages of whitefly comprising applying, by spray application, to plants a formulation comprising
at least one neonicotinyl insecticide,
at least one fatty alcohol ethoxylate of the formula (I), 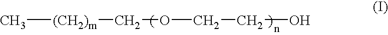
in which
m represents average values of between 8.0 and 13.0 and
n represents average values of between 6.0 and 17.0,
at least one solvent selected from the group consisting of dimethyl sulphoxide, N-methylpyrrolidone, butyrolactone, and mixtures thereof, and
optionally, additives.

2. The method according to claim 1, wherein the formulation comprises
between 0.1 and 30% by weight of fatty alcohol ethoxylate of the formula (I), in which
m represents average values of between 8.0 and 13.0 and
n represents average values of between 6.0 and 17.0,
between 1 and 50% by weight of at least one neonicotinyl insecticide,
between 1 and 80% by weight of a solvent selected from the group consisting of dimethyl sulphoxide, N-methylpyrrolidone butyrolactone, and mixtures thereof, and
between 0 and 20% by weight of additives.

3. The method according to claim 1, wherein the formulation comprises
between 0.1 and 30% by weight of fatty alcohol ethoxylate of the formula (I), in which
m represents average values of between 9.0 and 12.0 and
n represents average values of between 7.0 and 9.0,
between 1 and 50% by weight of at least one neonicotinyl insecticide,
between 1 and 80% by weight of a solvent selected from the group consisting of dimethyl sulphoxide, N-methylpyrrolidone butyrolactone, and mixtures thereof, and
between 0 and 20% by weight of additives.

4. (canceled)

5. (canceled)

6. (canceled)
